(19) United States
(12) Patent Application Publication
(10) Pub. No.: US 2007/0023084 A1
(43) Pub. Date: Feb. 1, 2007

(54) Valve module for a fluid-distribution system

(75) Inventor: George J. McHugh, Broomall, PA (US)

Correspondence Address: BUCHANAN, INGERSOLL & ROONEY PC, POST OFFICE BOX 1404, ALEXANDRIA, VA, 22313-1404, US

(73) Assignee: Cimberio Valve Co. Inc., Malvern, PA (US)

(21) Appl. No.: 11/190,821

(22) Filed: Jul. 28, 2005

(51) Int. Cl. F16K 27/12

(52) U.S. Cl. 137/382

(57) ABSTRACT

An enclosed valve module for a fluid-distribution system comprises a first main passageway for a fluid, a plurality of first branch passageways for the fluid, and a first plurality of valves with each of the valves selectively providing communication between the first main passageway and an associated one of the plurality of first branch passageways with a housing provided about the first plurality of valves, with the housing having an opening providing access to the first plurality of valves and with the opening being selectively closed by a member arranged to releasably and sealingly engage the housing about the opening with the first main passageway and each of the plurality of first branch passageways extending from inside of the housing to outside of the housing with the housing providing a substantially air-tight enclosure for the plurality of valves when the member sealingly engages the housing about said opening.

### FIELD OF THE INVENTION

The present invention relates to a valve module and especially to a commissioning module for a fluid-distribution system and more particularly relates to an enclosure for a valve or commissioning module for use in a heating and cooling system.

### BACKGROUND OF THE INVENTION

Fluid-distribution systems for heating and cooling systems typically employ water as the working fluid. During the commissioning of such systems it is typical to test the water integrity of the system, to flush and clean the system and, in addition, to adjust the flow rate of the working fluid in the various parts of the system. Periodic maintenance and occasional repairs typically also require access to the commissioning module for such a fluid-distribution system.

In a known commissioning module for a fluid-distribution system, a plurality of fluid-distribution valves are connected together to provide a first through-port which is in communication with a second through-port. The fluid-distribution valves include respective fluid outlet ports that communicate with the fluid passage through a fluid flow-control. A first isolating valve includes an inlet port and an outlet port with the outlet port being connected to the first through port of the plurality of fluid-distribution valves and the inlet port providing a fluid supply port of the commissioning module. Further isolating valves include an inlet port and an outlet port, with the inlet port being connected to the second through-port of the plurality of fluid-distribution valves and the outlet port being connected to a combined fluid-exhaust port of the commissioning module. A plurality of fluid flow-regulating valves, typically the same in number as the number of fluid-distribution valves, include respective inlet and outlet ports. The outlet ports are connected to the combined fluid-exhaust port of the commissioning module and another fluid flow-regulating valve is connected between the combined fluid-exhaust port and a further fluid exhaust port of the commissioning module. An arrangement for flow-rate measurement may be connected between the further fluid flow-regulating valve and the combined fluid-exhaust port of the commissioning module and typically at least one drain-off cock is connected to permit the draining of fluid from the commissioning module.

In operation, the commissioning module provides a supply fluid by way of the fluid supply port to the fluid outlet ports of the fluid-distribution valves and removes exhaust fluid by way of the further fluid-regulating valve to its further fluid-exhaust port.

### SUMMARY OF THE INVENTION

In the present invention, an enclosed valve module for a fluid-distribution system comprises a first main passageway for a fluid with a plurality of first branch passageways for the fluid. The valve module comprises a first plurality of valves with each of the valves selectively providing communication between the first main passageway and an associated one of the plurality of first branch passageways. A housing is provided about the first plurality of valves with the housing having an opening that provides access to the first plurality of valves. The opening is selectively closed by a member which is arranged to releasably and sealingly engage the housing about the opening with the first main passageway and each of the plurality of first branch passageways extending from inside of the housing to outside of the housing. The housing provides a substantially air-tight enclosure for the plurality of valves when the member sealingly engages the housing about the opening.

In a more preferred embodiment, the member is hingedly connected to the housing and the housing is insulated. In addition, it is preferable for the housing to be formed of metal such as galvanized steel. To absorb moisture within the air-tight housing, an anhydrous material or a desiccant may be provided within the housing.

The first main passageway for the fluid and each of the plurality of first branch passageways for the fluid preferably each comprise a coupling that is provided outside of the housing. In addition, the first main passageway for the fluid and each of the plurality of first branch passageways for the fluid each comprise piping with a threaded end portion that is provided outside of the housing.

In another preferred embodiment, the valve module comprises a second main passageway for the fluid and a plurality of second branch passageways for the fluid. A second plurality of valves is provided with each of the second plurality of valves selectively providing communication between the second main passageway and an associated one of the plurality of second branch passageways. The second plurality of valves is provided within the housing. Preferably, a first shut-off valve is provided for the first main passageway within the housing. In addition, a second shut-off valve is preferably provided for the second main passageway in the housing. A connecting passageway and connecting valve selectively provide fluid communication between the first plurality of valves and the second plurality of valves.

In another preferred embodiment of the present invention, a heating and cooling fluid-distribution system comprises an enclosed valve module comprising a first main passageway for a fluid and a plurality of first branch passageways for the fluid. The system further comprises a first plurality of valves, with each of the valves selectively providing communication between the first main passageway and an associated one of the plurality of first branch passageways. A housing is provided about the first plurality of valves with the housing having an opening that provides access to the first plurality of valves. The opening is selectively closed by a member which is arranged to releasably and sealingly engage the housing about the opening. The first main passageway and each of the plurality of first branch passageways extend from inside of the housing to outside of the housing. The housing provides a substantially air-tight enclosure for the plurality of valves when the member sealingly engages the housing about the opening. In addition, a plurality of heat exchangers are provided with each of the plurality of first branch passageways being in fluid communication with an associated one of the plurality of heat exchangers.

In a preferred embodiment, the member is hingedly connected to the housing and the housing is insulated. The housing is preferably formed of metal, such as galvanized steel. If desired, an anhydrous material or a desiccant may be provided within the housing. The first main passageway for the fluid and each of the plurality of first branch passageways for the fluid each comprise a coupling which is provided outside of the housing.

In another preferred embodiment, the first main passageway for the fluid and each of the plurality of first branch passageways for the fluid each comprise piping with a threaded end portion provided outside of the housing.

In another preferred embodiment, a second main passageway is provided for the fluid with a plurality of second branch passageways for the fluid. A second plurality of valves is provided with each of the second plurality of valves selectively providing communication between the second main passageway and an associated one of the plurality of second branch passageways. The second plurality of valves is provided within the housing with each of the plurality of second branch passageways being in fluid communication with an associated one of the plurality of heat exchangers.

In another preferred embodiment, a first shut-off valve is provided for the first main passageway within the housing. A second shut-off valve for the second main passageway may be provided within the housing. A connecting passageway and a connecting valve may be provided to selectively provide fluid communication between the first plurality of valves and the second plurality of valves.

The first main passageway preferably supplies water at a predetermined temperature to the first plurality of valves at a predetermined temperature of about 50 degrees F. for cooling.

### BRIEF DESCRIPTION OF DRAWINGS

The present invention will appear more clearly from the following detailed description of several embodiments illustrated in the enclosed figures in which:

FIG. 1 is a diagrammatic representation of a prior art commissioning module,

FIG. 2 is a diagrammatic representation of a transverse cross-section through a fluid-distribution valve included in a flow manifold which forms a part of the commissioning module of FIG. 1 according to the prior art;

FIG. 3 is a diagrammatic representation of a fluid-distribution system including the commissioning module of FIG. 1 as a control element according to the prior art;

FIG. 4 is a diagrammatic representation of an enclosed commissioning module in partial cross section according to the present invention;

FIG. 5 is a diagrammatic representation of a top view of the enclosed commissioning module of FIG. 4 according to the present invention; and,

FIG. 6 is a side view of the enclosed commissioning module of FIG. 5.

### DETAILED DESCRIPTION OF THE PREFERRED EMBODIMENTS

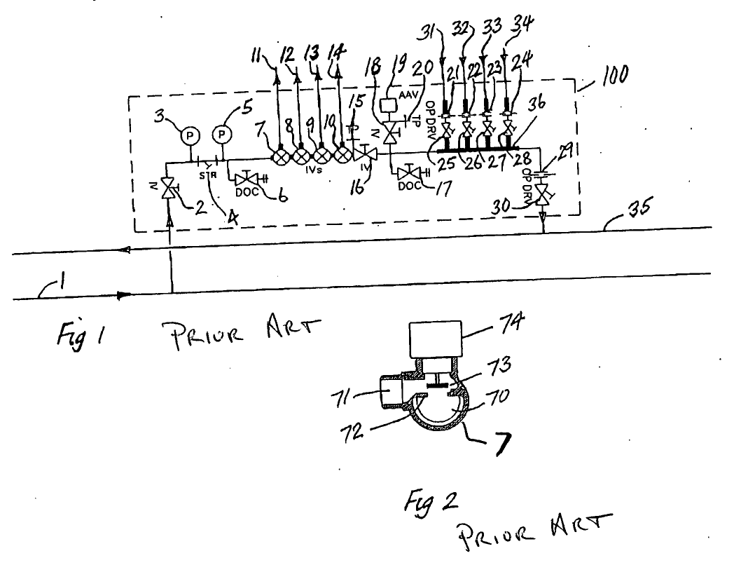

With reference to FIG. 1 of the accompanying drawings, a particular commissioning module 100 according to the prior art is shown in U.K. Patent Application No. GB 2 376 066 A and US Patent Application Publication US 2005/0109482 of May 26, 2005 which are both incorporated by reference. That particular commissioning module includes in series a first isolating valve 2, a strainer 4, a first drain-off cock 6, and first, second, third and fourth fluid-distribution valves 7, 8, 9, and 10. The commissioning valve also includes a second isolating valve 16, a second drain-off cock 17, a third isolating valve 18, and an automatic air vent 19 in selective fluid communication with the fluid-distribution valves 7, 8, 9, and 10. In addition, first, second, third and fourth orifice plates 21, 22, 23 and 24, first, second, third and fourth double regulating valves 25, 26, 27 and 28, a fifth orifice plate 29 and a fifth double regulating valve 30 are also provided in selective fluid communication with the second isolating valve 16. The commissioning module 100 further includes first and second test points 3 and 5 with the strainer 4 located therebetween. A third test point 15 is located adjacent to a port of the second isolating valve 16 and a fourth test point 20 is located adjacent to a port of the third isolating valve 18.

The first isolating valve 2 has a fluid-inlet and a fluid-outlet port with the fluid-inlet port of the first isolating valve providing a fluid-supply port for the commissioning module 100. The strainer 4 has a fluid-inlet port and a fluid-outlet port. The fluid-outlet port of the first isolating valve 2 is connected to the fluid-inlet port of the strainer 4. The fluid-outlet port of the strainer 4 is connected to a fluid-inlet port of a drain off cock 6 and the fluid-outlet port of the strainer 4 is also connected to the first fluid-distribution valve 7.

With reference to FIG. 2, the fluid-distribution valve 7 has a housing providing a fluid passage-way 70 connecting together a first through-port and a second through-port, and permitting the uninterrupted flow of fluid between the first and second through-ports by way of the fluid passage 70. The fluid-distribution valve includes an outlet port 71 which communicates with the fluid passage 70 by way of an aperture in a valve seat member 72. A movable valve member 73 is controlled by a screw control member 74 which, when rotated clockwise, moves the valve member 73 into engagement with the valve seat member 72, thereby isolating the fluid-outlet port 71 from the fluid passage 70. Connection between the outlet port 71 and the fluid passage 70 is effected by anti-clockwise rotation of the control member 74, thereby moving the movable valve member 73 away from the valve seat member 72.

The first, second, third and fourth fluid-distribution valves 7, 8, 9 and 10 are the same form of valve and the above description of the first fluid-distribution valve 7 is applicable to the second, third and fourth fluid-distribution valves 8, 9 and 10.

Referring again to FIG. 1, the fluid-outlet port of the strainer 4 is connected to the first through-port of the first fluid-distribution valve 7. The second through-port of the first fluid-distribution valve 7 is connected to the first through-port of the second fluid-distribution valve 8. The second through-port of the second fluid-distribution valve 8 is connected to the first through-port of the third fluid-distribution valve 9 and the second through-port of the third fluid-distribution valve 9 is connected to the first through-port of the fourth fluid-distribution valve 10. The output ports of the first, second, third and fourth fluid-distribution valves 7, 8, 9 and 10 are connected to supply fluid lines 11, 12, 13 and 14, respectively, belonging to a fluid-distribution system including the commissioning module.

The second through-port of the fourth fluid-distribution valve 10 is connected to the inlet port of the second isolating valve 16. The outlet port of the second isolating valve 16 is connected to the inlet port of a third isolating valve 18 and to the second drain-off cock 17. The outlet port of the third isolating valve 18 is connected to an automatic air vent 19.

The second isolating valve 16, which is usually shut, serves to separate the fluid-supply part of a fluid-distribution system, which includes the commissioning module, from the fluid-exhaust part of the fluid-distribution system. When the second isolating valve 16 is open it serves as a bypass route between the fluid-supply and fluid-exhaust parts of the system. Consequently, the second drain-off cock 17, the third isolating valve 18 and the automatic air vent serve as components of the fluid-exhaust part of the fluid-distribution system.

A fluid-exhaust line 31 of a fluid-distribution system which includes the commissioning module is connected to the inlet port of the first orifice plate 21 which has an inlet port and an outlet port. The outlet port of the orifice plate is connected to the inlet port of the first double regulating valve 25 and the outlet port of the double regulating valve 25 is connected to the outlet port of the second isolating valve 16.

Additional fluid-exhaust lines 32, 33 and 34 of the fluid-distribution system are connected to the respective inlet ports of the second, third and fourth orifice plates 22, 23 and 24. The outlet ports of the orifice plates are connected to the inlet ports of the double regulating valves 26, 27 and 28, respectively, and the outlet ports of the double regulating valves 26, 27 and 28 are connected to the outlet port of the second isolating valve 16 by a length of conduit 36 serving as a combined fluid-exhaust port. The outlet ports of the double regulating valves 25, 26, 27 and 28 are connected also to the inlet port of the fifth orifice plate 29. The outlet port of the fifth orifice plate 29 is connected to the inlet port of the fifth double regulating valve 30 and the outlet port of the fifth double regulating valve 30 provides a further fluid-exhaust port of the commissioning module 100.

Alternative arrangements include the positioning of the second drain-off cock 17, the third isolating valve 18 and the automatic air vent 19 adjacent to the fourth double regulating valve 28 rather than as shown in FIG. 1 where the second drain-off cock 17, the third isolating valve 18 and the automatic air vent 19 are positioned adjacent to the first double regulating valve 25.

As is shown in FIG. 1, the fluid-distribution valves 7, 8, 9 and 10 are grouped together to form a fluid supply-manifold with the first through-port of the first fluid distribution valve 7 and the second through-port of the fourth fluid-distribution valve 10 providing through-ports of the fluid supply-manifold. A through-passage is provided between those through-ports of the manifold.

Also as shown in FIG. 1, the first, second, third and fourth orifice plates 21, 22, 23 and 24 with the first, second, third and fourth double regulating valves 25, 26, 27 and 28 are so grouped together with appropriate connection components, including the length of fluid conduit 36, to form a fluid exhaust-manifold.

In operation of the commissioning module 100, the fluid-distribution valves 7, 8, 9 and 10 supply a working fluid to respective heat exchangers by way of fluid supply lines 11, 12, 13 and 14 and the working fluid returns from the heat exchangers by way of fluid exhaust lines 31, 32, 33 and 34. The exhaust flow of the working fluid passes through the orifice plates 21, 22, 23 and 24 to the double regulating valves 25, 26, 27 and 28 to the fifth orifice plate 29 and to the fifth double regulating valve 30. The fifth orifice plate 25 is used to measure the overall flow rate for the commissioning module (the pressure drop across an orifice plate is an indication of flow rate) and the orifice plates 21, 22, 23 and 24 are selected to measure the flow rates for the respective fluid supply-exhaust lines 11-31, 12-32, 13-33 and 14-34. The fifth double regulating valve 30 effects adjustment of the overall flow rate and the double regulating valves 25, 26, 27 and 28 effect the adjustment of the individual flow rates for the respective fluid supply-exhaust lines 11-31, 12-32, 13-33 and 14-34. The automatic air vent 19 operates to vent air from the system when the third isolating valve 18 is open. The strainer 4 serves as a filter and removes particulate material from the working fluid. The test points 3 and 5 permit the monitoring of the pressure drop across the strainer 4, a rise in the pressure drop indicating the need to remove and clean the strainer 4. Closure of the first isolating valve 2 effects the shut-off of supply fluid for removal of the strainer 4 or for any other reason requiring the shut-off of supply fluid. The first and second drain-off cocks 6 and 17 permit the system to be drained of fluid when the first isolating valve 2 is shut.

The commissioning module 100 permits the filling and pressure testing of a fluid-distribution system to which it belongs by use of the test point 15 for monitoring the fluid supply pressure and the test point 20 for monitoring the fluid exhaust pressure. The fluid flow rates throughout the fluid-distribution system are balanced in order to ensure that all parts of the system receive an adequate proportion of the total flow from the supply by the use of the double regulating valves 25, 26, 27 and 28. The commissioning module itself is flushed and cleaned by opening the second isolating valve 16, the strainer 4 effecting the removal of dirt, and the system as a whole is flushed and cleaned by closure of the second isolating valve 16.

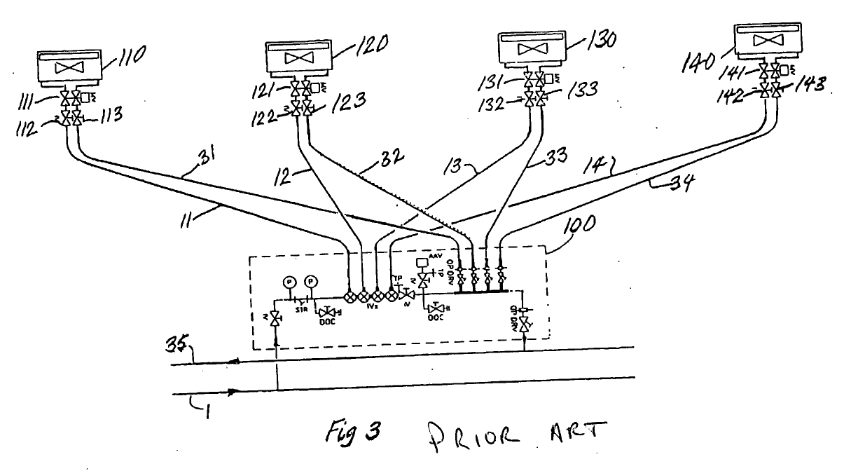

With reference now to FIG. 3, a fluid-distribution system according to the prior art including the commissioning module 100 and fluid supply-exhaust lines 11-31 includes a first heat exchanger 110 connected to the fluid supply-exhaust line 11-31 by way of a first motorised valve 111 and fourth and fifth isolating valves 112 and 113.

In addition, second, third and fourth heat exchangers 120, 130 and 140 are connected to the fluid supply-exhaust lines 12-32, 13-33 and 14-34 by way of respective motorised valves 121, 131 and 141 and isolating valves 122, 123, 132, 133, 142 and 143.

The commissioning of the fluid-distribution system is effected by the commissioning module 100 principally by the use of the components of the commissioning module 100 and the commissioning module 100 typically remains connected into the fluid-distribution system and serves as a component of the system.

The motorised valves 111, 121, 131 and 141 serve to control the fluid flow through the heat exchangers 110, 120, 130 and 140 as instructed by a controller (not shown) and the isolating valves 112, 113, 122, 123, 132, 133, 142 and 143 serve as conventional isolation valves.

The fluid-distribution system may be a heating system, a cooling system, or a combined heating and cooling system and the working fluid may be water.

The commissioning module 100 as shown in FIGS. 1 and 3 is capable of operation in a fluid-distribution system including up to 4 heat exchangers and it will be appreciated that more heat exchangers could be accommodated by increasing the number of fluid-distribution valves and the number of orifice plate-double regulating valve pairs as necessary.

The fluid supply-exhaust lines 11-31, 12-32, 13-33 and 14-34 may be flexible plastic-coated aluminum pipes which may be installed more quickly than rigid pipes such as copper pipes. The components of the commissioning module 100 are typically made of a corrosion-resistant material.

According to the prior art, the commissioning module shown in FIG. 1 may be modified to include a further isolating valve between the length of fluid conduit 36 and the isolating valve 16 with the drain-off cock 17 then being connected to the junction between the isolating valve 16 and the further isolating valve. The drain-off cock 6 may be omitted when the further isolating valve is present.

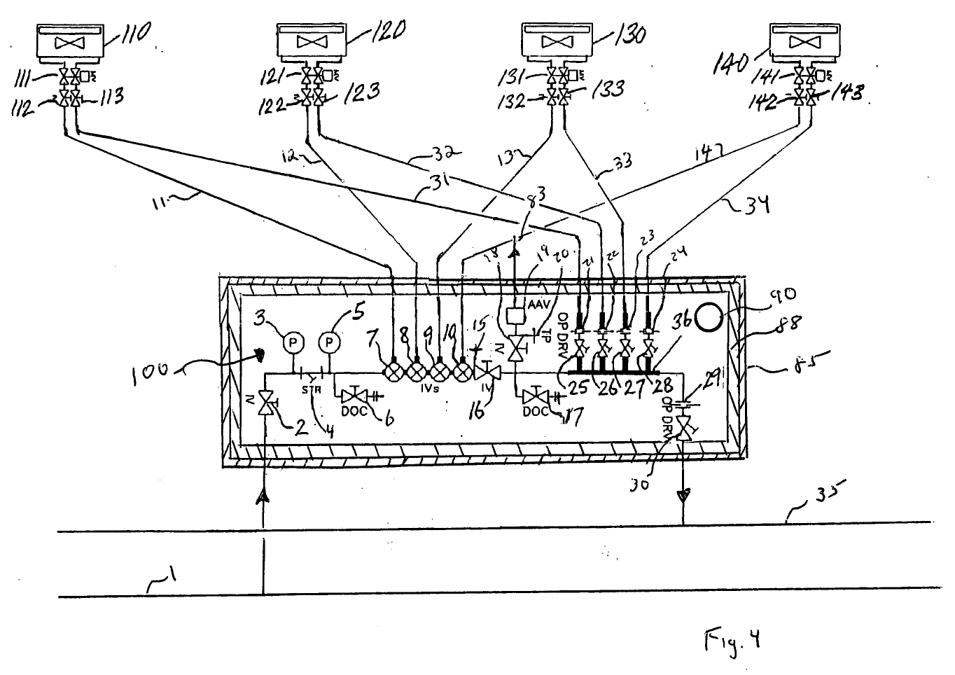

With reference now to FIG. 4, an enclosed valve module according to the present invention includes a housing 85 which is provided about a valve module such as the commissioning valve 100 of FIG. 1. The housing 85 is preferably a rectangular box which is configured so as to comfortably enclose the valves and piping and various ports of the commissioning valve 100 in a compact and efficient arrangement.

The housing 85 is preferably made of metal, and more preferably made of galvanized steel in order to provide adequate strength for the housing. Galvanized steel is preferred to minimize maintenance of the housing and to avoid rust or other deterioration of the housing from moisture. As shown, the housing 85 is also insulated about the interior surface of the housing. The insulation may comprise a layer 88 of any suitable, conventional insulating material such as fiberglass or polyethylene provided on the inside of the metal housing. The thickness of the insulation as well as the “R” value of the insulation is a matter of choice and suitable thicknesses and “R” values are readily apparent to one skilled in the art of heating and cooling systems.

The housing enclosing the commissioning module is expected to be typically mounted either in a ceiling of a room of a dwelling or within a wall of the dwelling. If the housing is mounted within a wall or in a ceiling, a door or other opening that provides access to the housing will enable a service person or technician to have access to the housing of the commissioning module as appropriate. In addition, suitable mounting brackets (not shown) may be provided to enable the housing to be easily secured to framing within the ceiling or wall where the housing is to be provided.

Preferably, all of the valving and other components of the commissioning valve are provided within the housing as shown in FIG. 4. However, it may be preferable to provide less than all of the valving and components within the housing. For example, the first isolating valve 2 or an additional shut-off valve may be provided, if desired, outside of the housing rather than inside of the housing. In addition, it may be desirable to provide a substantially air-tight housing according to the present invention for a valve module that comprises only the fluid-distribution valves 7, 8, 9, and 10 along with the main supply passageway that provides a fluid connection to the valves 7, 8, 9, and 10. Similarly, it may be desirable to provide a substantially air-tight housing according to the present invention for a valve module that comprises the regulating valves 25, 26, 27, and 28 along with the return passageway providing fluid connection to the valves 25, 26, 27, and 28.

In the preferred embodiment, the commissioning valve 100 as described in connection with FIG. 1 is provided within the housing 85 including in series the first isolating valve 2, the strainer 4, the first drain-off cock 6, and the first, second, third and fourth fluid-distribution valves 7, 8, 9, and 10. The second isolating valve 16, the second drain-off cock 17, the third isolating valve 18, and the automatic air vent 19 are provided in selective communication with the fluid-distribution valves 7, 8, 9, and 10. As shown in FIG. 4, the automatic air vent 19 preferably has an outlet which passes through the housing 85 so as not to vent into the housing.

As described in connection with FIG. 1, the first, second, third and fourth orifice plates 21, 22, 23 and 24, and the first, second, third and fourth double regulating valves 25, 26, 27 and 28, the fifth orifice plate 29 and the fifth double regulating valve 30 are also provided in selective fluid communication with the second isolating valve 16 within the housing 85. The first and second test points 3 and 5 with the strainer 4 located therebetween are similarly preferably provided within the housing 85 along with the third test point 15 which is located adjacent to the port of the second isolating valve 16 and the fourth test point 20 located adjacent to the port of the third isolating valve 18.

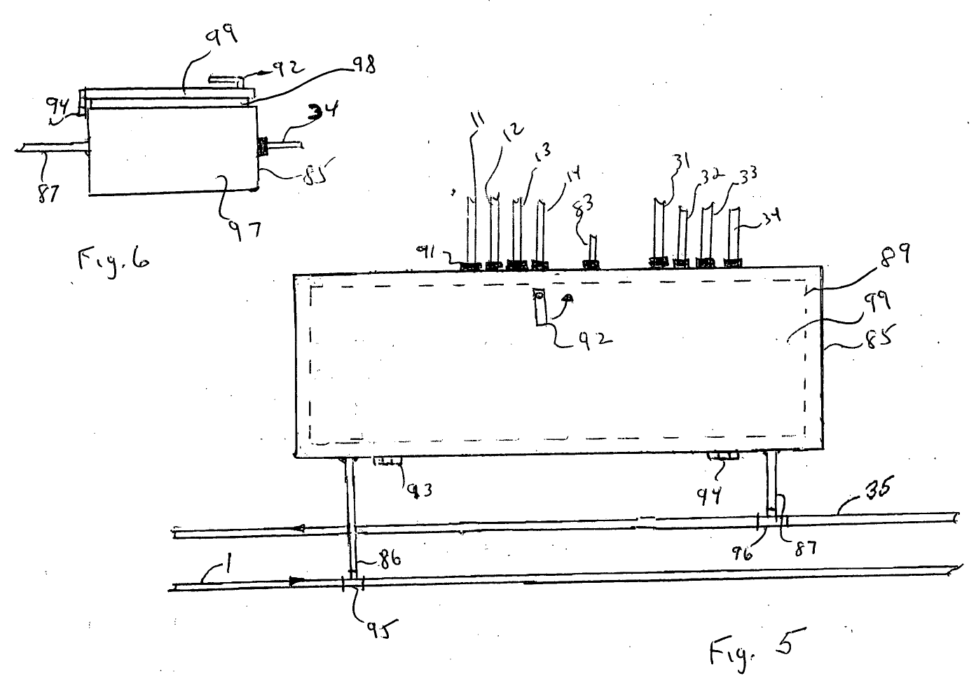

With reference now to FIG. 5, the housing 85 defines an opening 89 (shown in phantom in FIG. 5) and includes a member 99 or lid which is preferably pivotally connected to the housing through a pair of hinges 93, 94. The lid 99 preferably includes a latch (not shown) operated by a handle 92 to permit the housing to be selectively opened and closed. The lid 99 corresponds generally to the opening of the housing so that the lid may selectively close the housing or permit access, as desired, to the interior of the housing. With reference to FIG. 6, a sealing material or gasket 98 is provided on the lid 99 about the periphery of the opening 89 in order to provide a substantially air-tight seal for the lid when positioned adjacent to the opening 89 of the housing.

If desired, the lid may be releasably and sealingly secured to the housing 85 in other suitable and conventional manners readily apparent to one skilled in the art of air-tight enclosures. For example, the lid may be bolted to the housing or a series of latches may be provided about a periphery of the lid to maintain the lid in position adjacent the opening in the housing. However, if the lid is not joined to the housing by hinges, it may be appropriate or even required by local regulations to provide safety chains or another mechanism to prevent the lid from falling onto an individual below the housing.

As shown in FIGS. 5 and 6, a number of conduits or pipes pass through walls of the housing in order to provide fluid communication with the components of the commissioning valve. For example, a conduit 86 provides communication between the inlet of the valve 2 and the line 1 through a T-coupling 95. Similarly, a conduit 87 provides communication between the outlet of the valve 30 and the line 35 through a T-coupling 96. In this preferred embodiment, the piping members or conduits 86 and 87 are provided with threaded ends which are engaged into an associated opening in the T-couplings 95, 96. As desired, the conduits 86 and 87 may extend through associated openings in one or more walls of the housing 85 with the openings about the conduits being sealed in a substantially air-tight configuration. In another preferred arrangement, a pipe coupling 91 is provided within an opening in the housing and then piping such as the conduit or line 11 is connected to the coupling on either side of the housing wall. Again, the pipe coupling, if used, would be sealed with respect to the opening through the housing in a substantially air-tight manner. In any event, it is preferable that the various conduits for the commissioning module that need to communicate through the housing 85 be sealed with respect to the housing and arranged for easy plumbing connection and disconnection without disrupting the substantially air-tight seal with the housing.

With continued reference to FIG. 4, in the fluid-distribution system a first heat exchanger 110 is connected to the fluid supply-exhaust line 11-31 by way of a first motorised valve 111 and fourth and fifth isolating valves 112 and 113.

In addition, second, third and fourth heat exchangers 120, 130 and 140 are connected to the fluid supply-exhaust lines 12-32, 13-33 and 14-34 by way of respective motorised valves 121, 131 and 141 and isolating valves 122, 123, 132, 133, 142 and 143.

The commissioning of the fluid-distribution system is effected by the commissioning module 100 principally by the use of the components of the commissioning module 100 and the commissioning module 100 typically remains connected into the fluid-distribution system and serves as a component of the system.

The motorised valves 111, 121, 131 and 141 serve to control the fluid flow through the heat exchangers 110, 120, 130 and 140 as instructed by a controller (not shown) and the isolating valves 112, 113, 122, 123, 132, 133, 142 and 143 serve as conventional isolation valves.

The fluid-distribution system may be a heating system, a cooling system, or a combined heating and cooling system and the working fluid may be water.

During operation of the commissioning module as part of a heating and cooling system, the various conduits and components of the commissioning module transport a fluid such as water at a temperature which is much lower than the surrounding environment. For example, during a cooling condition, the water in the commissioning module may be at about 50° F. or even about 40° F. while the ambient air temperature is perhaps 90° F. or 100° F. If the commissioning module and housing are located within a ceiling above the typical insulation for the dwelling, the ambient air temperature may be considerably higher. Typically, such ambient air is also very humid, especially during the summer when the system is being used for cooling. If the commissioning module were exposed to the ambient air, the significant temperature differential and relatively high humidity would likely produce condensation on the components of the commissioning module.

In the enclosed commissioning module according to the present invention, however, the sealed housing substantially eliminates or at least significantly limits the amount of condensate that may form on the commissioning module during a cooling operation. Similarly, if the housing is adequately insulated, the formation of condensation on the exterior of the housing is likewise substantially eliminated or significantly limited.

The formation of condensation on the commissioning module could be particularly troublesome because of the potential for water to drip from the commissioning module to the ceiling or other adjacent surface. In addition, the formation of condensate on the commissioning module may present another significant problem by providing an environment in which mold or fungus may thrive. The formation of mold and fungus in dwelling walls and ceilings has become a very serious concern for the building industry including in particular the heating and cooling industry.

In addition to insulating the housing 85 for the commissioning module, it may be preferable to insulate the piping and conduits communicating both with the various heat exchangers 110-140 as well as with the source of cooling water and the main cool water return line. Such insulation is relatively easy to provide and would substantially eliminate or limit the formation of condensate on such piping and conduits. However, due to the need for access to the various valves and plumbing connections associated with the commissioning valve, it is impractical to adequately insulate the commissioning valve to prevent or limit the formation of condensation. Instead, in accordance with the present invention, by providing the commissioning module within an air-tight enclosure which provides selective access to the commissioning module, the formation of troublesome condensate (and the growth of mold and fungus) can be controlled or substantially eliminated.

To further reduce the formation of condensate within the housing 85, it may be preferable to provide a desiccant or a supply of an anhydrous material 90. The desiccant or anhydrous material absorbs water vapor from the air and thereby reduces or eliminates the formation of condensation even from the limited quantity of air within the sealed housing 85.

In operation of the commissioning module enclosed within the housing 85, the fluid-distribution valves 7, 8, 9 and 10 supply a working fluid, such as water, to the respective heat exchangers 110-140 by way of the fluid supply lines 11, 12, 13 and 14 and the working fluid returns from the heat exchangers by way of the fluid exhaust lines 31, 32, 33 and 34. The exhaust flow of the working fluid passes through the orifice plates 21, 22, 23 and 24 to the double regulating valves 25, 26, 27 and 28 to the fifth orifice plate 29 and to the fifth double regulating valve 30. The fifth orifice plate 25 is used to measure the overall flow rate for the commissioning module (the pressure drop across an orifice plate is an indication of flow rate) and the orifice plates 21, 22, 23 and 24 are selected to measure the flow rates for the respective fluid supply-exhaust lines 11-31, 12-32, 13-33 and 14-34. The fifth double regulating valve 30 effects adjustment of the overall flow rate and the double regulating valves 25, 26, 27 and 28 effect the adjustment of the individual flow rates for the respective fluid supply-exhaust lines 11-31, 12-32, 13-33 and 14-34.

The automatic air vent 19 operates to vent air from the system when the third isolating valve 18 is open. To avoid venting of humid air into the housing 85, the automatic air vent 19 preferably has an outlet 83 which extends through the wall of the housing 85. The conduit of the outlet 83 is sealed in an air-tight manner with respect to the housing wall to maintain the housing in a substantially air-tight configuration when the lid is closed.

The strainer 4 serves as a filter and removes particulate material from the working fluid. The test points 3 and 5 permit the monitoring of the pressure drop across the strainer 4, a rise in the pressure drop indicating the need to remove and clean the strainer 4. Closure of the first isolating valve 2 effects the shut-off of the supply fluid for the removal of the strainer 4 or for any other reason which requires the shut-off of supply fluid.

The first and second drain-off cocks 6 and 17 permit the system to be drained of fluid when the first isolating valve 2 is shut. It is not necessary for the drain-off cocks 6 and 17 to have outlets that extend through the housing wall because the drain-off cocks 6 and 17 are normally closed except when the housing lid is open. During a drain-off operation, typically plumbing lines leading to a suitable, conventional drain would be connected temporarily to the outlet of each of the drain-off cocks 6 and 17.

The principles, preferred embodiments and mode of operation of the present invention have been described in the foregoing specification. However, the invention which is intended to be protected is not to be construed as limited to the particular embodiments disclosed. The embodiments are therefore to be regarded as illustrative rather than as restrictive. Variations and changes may be made without departing from the spirit of the present invention. Accordingly, it is expressly intended that all such equivalents, variations and changes which fall within the spirit and scope of the present invention as defined in the claims be embraced thereby.

What is claimed is:

1. An enclosed valve module for a fluid-distribution system, comprising:
a first main passageway for a fluid;
a plurality of first branch passageways for said fluid;
a first plurality of valves, each of said valves selectively providing communication between said first main passageway and an associated one of said plurality of first branch passageways;
a housing provided about said first plurality of valves, said housing having an opening providing access to said first plurality of valves, said opening being selectively closed by a member arranged to releasably and sealingly engage said housing about said opening, said first main passageway and each of said plurality of first branch passageways extending from inside of said housing to outside of said housing, said housing providing a substantially air-tight enclosure for said plurality of valves when said member sealingly engages said housing about said opening.

2. The enclosed valve module of claim 1, wherein said member is hingedly connected to said housing.

3. The enclosed valve module of claim 1, wherein said housing further comprises insulation.

4. The enclosed valve module of claim 1 wherein said housing is formed of metal.

5. The enclosed valve module of claim 4 wherein said housing is comprised of galvanized steel.

6. The enclosed valve module of claim 1 further comprising an anhydrous material provided within said housing.

7. The enclosed valve module of claim 1 further comprising a desiccant provided within said housing.

8. The enclosed valve module of claim 1 wherein said first main passageway for said fluid and each of said plurality of first branch passageways for said fluid each comprise a coupling provided outside of said housing.

9. The enclosed valve module of claim 1 wherein said first main passageway for said fluid and each of said plurality of first branch passageways for said fluid each comprise piping with a threaded end portion provided outside of said housing.

10. The enclosed valve module of claim 1, further comprising
a second main passageway for said fluid;
a plurality of second branch passageways for said fluid;
a second plurality of valves, each of said second plurality of valves selectively providing communication between said second main passageway and an associated one of said plurality of second branch passageways;
said second plurality of valves being provided within said housing.

11. The enclosed valve module of claim 10, further comprising a first shut-off valve for said first main passageway.

12. The enclosed valve module of claim 10 wherein said first shut-off valve for said first main passageway is provided within said housing.

13. The enclosed valve module of claim 11 further comprising a second shut-off valve for said second main passageway.

14. The enclosed valve module of claim 13 wherein said first shut-off valve and said second shut-off valve are both provided within said housing.

15. The enclosed valve module of claim 14 further comprising a connecting passageway and connecting valve selectively providing fluid communication between said first plurality of valves and said second plurality of valves.

16. A heating and cooling fluid-distribution system comprising an enclosed valve module, comprising:
a first main passageway for a fluid;
a plurality of first branch passageways for said fluid;
a first plurality of valves, each of said valves selectively providing communication between said first main passageway and an associated one of said plurality of first branch passageways;
a housing provided about said first plurality of valves, said housing having an opening providing access to said first plurality of valves, said opening being selectively closed by a member arranged to releasably and sealingly engage said housing about said opening, said first main passageway and each of said plurality of first branch passageways extending from inside of said housing to outside of said housing, said housing providing a substantially air-tight enclosure for said plurality of valves when said member sealingly engages said housing about said opening;
a plurality of heat exchangers, each of said plurality of first branch passageways being in fluid communication with an associated one of said plurality of heat exchangers.

17. The heating and cooling fluid-distribution system of claim 16, wherein said member is hingedly connected to said housing.

18. The heating and cooling fluid-distribution system of claim 16, wherein said housing further comprises insulation.

19. The heating and cooling fluid-distribution system of claim 16 wherein said housing is formed of metal.

20. The heating and cooling fluid-distribution system of claim 19 wherein said housing is comprised of galvanized steel.

21. The heating and cooling fluid-distribution system of claim 16 further comprising an anhydrous material provided within said housing.

22. The heating and cooling fluid-distribution system of claim 16 further comprising a desiccant provided within said housing.

23. The heating and cooling fluid-distribution system of claim 16 wherein said first main passageway for said fluid and each of said plurality of first branch passageways for said fluid each comprise a coupling provided outside of said housing.

24. The heating and cooling fluid-distribution system of claim 16 wherein said first main passageway for said fluid and each of said plurality of first branch passageways for said fluid each comprise piping with a threaded end portion provided outside of said housing.

25. The heating and cooling fluid-distribution system of claim 16, further comprising
a second main passageway for said fluid;
a plurality of second branch passageways for said fluid;
a second plurality of valves, each of said second plurality of valves selectively providing communication between said second main passageway and an associated one of said plurality of second branch passageways;
said second plurality of valves being provided within said housing, each of said plurality of second branch passageways being in fluid communication with an associated one of said plurality of heat exchangers.

26. The heating and cooling fluid-distribution system of claim 25, further comprising a first shut-off valve for said first main passageway.

27. The heating and cooling fluid-distribution system of claim 26 wherein said first shut-off valve for said first main passageway is provided within said housing.

28. The heating and cooling fluid-distribution system of claim 27 further comprising a second shut-off valve for said second main passageway.

29. The heating and cooling fluid-distribution system of claim 28 wherein said first shut-off valve and said second shut-off valve are both provided within said housing.

30. The heating and cooling fluid-distribution system of claim 29 further comprising a connecting passageway and connecting valve selectively providing fluid communication between said first plurality of valves and said second plurality of valves.

31. The heating and cooling fluid-distribution system of claim 16 wherein said first main passageway supplies water at a predetermined temperature to said first plurality of valves.

32. The heating and cooling fluid-distribution system of claim 25 wherein said first main passageway supplies water at a predetermined temperature of about 50 degrees F. to said first plurality of valves, said first plurality of valves supplying the water to said heat exchangers for cooling.
